(19) United States
(12) Patent Application Publication
(10) Pub. No.: US 2019/0057049 A1
(43) Pub. Date: Feb. 21, 2019

(54) MEMORY SYSTEM AND OPERATING METHOD THEREOF

(71) Applicant: SK hynix Inc., Gyeonggi-do (KR)

(72) Inventors: Duck Hoi KOO, Gyeonggi-do (KR); Soong Sun SHIN, Gyeonggi-do (KR); Yong Tae KIM, Seoul (KR); Cheon Ok JEONG, Gyeonggi-do (KR)

(21) Appl. No.: 15/845,475

(22) Filed: Dec. 18, 2017

(30) Foreign Application Priority Data
Aug. 18, 2017 (KR) 10-2017-0104992

(51) Int. Cl. G06F 13/16; G06F 12/02

(52) U.S. Cl. CPC G06F 13/1668; G06F 2212/202; G06F 13/1621; G06F 12/0238

(57) ABSTRACT

A memory system includes a nonvolatile memory device including a plurality of planes; and a controller suitable for determining whether a first read operation for the nonvolatile memory device is a random read operation, and accessing at least one first target plane of the first read operation, according to an access merge process, depending on a determination result, wherein the controller simultaneously accesses the first target plane and at least one second target plane included in the nonvolatile memory device, according to the access merge process.

### CROSS-REFERENCES TO RELATED APPLICATION

The present application claims priority under 35 U.S.C. § 119(a) to Korean application number 10-2017-0104992, filed on Aug. 18, 2017, which is herein incorporated by reference in its entirety.

### BACKGROUND

### 1. Technical Field

Various embodiments generally relate to a memory system, and, more particularly, to a memory system including a nonvolatile memory device.

### 2. Related Art

Memory systems store data provided by an external device in response to a write request. Memory systems may also provide stored data to an external device in response to a read request. Examples of external devices that use memory systems include computers, digital cameras, cellular phones and the like. Memory systems may be embedded in an external device during manufacturing of the external devices or may be fabricated separately and then connected afterwards to an external device.

### SUMMARY

In an embodiment, a memory system may include: a nonvolatile memory device including a plurality of planes; and a controller suitable for determining whether a first read operation for the nonvolatile memory device is a random read operation, and accessing at least one first target plane of the first read operation, according to an access merge process, depending on a determination result, wherein the controller simultaneously accesses the first target plane and at least one second target plane included in the nonvolatile memory device, according to the access merge process.

In an embodiment, a method for operating a memory system may include: determining whether a first read operation for a nonvolatile memory device is a random read operation; and accessing at least one first target plane of the first read operation, according to an access merge process, depending on a determination result, the accessing of the first target plane according to the access merge process comprising simultaneously accessing the first target plane and at least one second target plane included in the nonvolatile memory device.

In an embodiment, an operation method of a controller may include: queuing a first random access operation into a queue, wherein a first target access unit is a target of the first random access operation; detecting one or more second target access units to form a simultaneously accessible unit together with the first target access unit, wherein the second target access unit is a target of a second random access operation in the queue; and simultaneously performing the first and second random access operations to the simultaneously accessible unit, wherein the first and second target access units of the simultaneously accessible unit are simultaneously accessed with a single access.

In an embodiment, an operation method of a controller may include: queuing a first sequential access operation into a queue, wherein one or more first target access units are targets of the first sequential access operation; performing the first sequential access operation to one or more first simultaneously accessible units each including the first target access units; detecting one or more second target access units to form a simultaneously accessible unit together with one or more first target access units other than the first target access units of the first simultaneously accessible units, wherein the second target access unit is a target of a second sequential access operation in the queue; and simultaneously performing the first and second sequential access operations to the second simultaneously accessible unit, wherein the first target access units of the first simultaneously accessible unit are simultaneously accessed with a single access, and wherein the first and second target access units of the second simultaneously accessible unit are simultaneously accessed with a single access.

### BRIEF DESCRIPTION OF THE DRAWINGS

The above and other features and advantages of the present invention will become more apparent to those skilled in the art to which the present invention belongs by describing various embodiments thereof with reference to the attached drawings in which:

FIG. 1 is a block diagram illustrating an example of a memory system in accordance with an embodiment.

FIG. 2 is a block diagram illustrating an example of the detailed configuration of a nonvolatile memory device.

FIG. 3A is an example of a diagram to assist in the description of a method for the nonvolatile memory device of FIG. 2 to perform an access operation for target planes.

FIG. 3B is an example of a diagram to assist in the description of a method for the nonvolatile memory device of FIG. 2 to perform an access operation for target planes.

FIG. 3C is an example of a diagram to assist in the description of a method for the nonvolatile memory device of FIG. 2 to perform an access operation for target planes.

FIG. 4 is an example of a diagram to assist in the description of a method for an access merge circuit to merge access requests.

FIG. 5 is an example of a diagram to assist in the description of a method for the access merge circuit to process a sequential access operation.

FIG. 6 is an example of a flow chart to assist in the description of a method for operating the memory system of FIG. 1, in accordance with an embodiment.

FIG. 7 is an example of a flow chart to assist in the description of a method for operating the memory system of FIG. 1, in accordance with an embodiment.

FIG. 8 is an example of a flow chart to assist in the description of a method for operating the memory system of FIG. 1, in accordance with an embodiment.

FIG. 9 is a diagram illustrating a data processing system including a solid state drive (SSD) in accordance with an embodiment.

FIG. 10 is a diagram illustrating a data processing system including a memory system in accordance with an embodiment.

FIG. 11 is a diagram illustrating a data processing system including a memory system in accordance with an embodiment.

FIG. 12 is a diagram illustrating a network system including a memory system in accordance with an embodiment.

FIG. 13 is a block diagram illustrating a nonvolatile memory device included in a memory system in accordance with an embodiment.

### DETAILED DESCRIPTION

Hereinafter, a memory system and an operating method thereof according to the present invention will be described with reference to the accompanying drawings through exemplary embodiments of the present invention. The present invention may, however, be embodied in different forms and should not be construed as being limited to the embodiments set forth herein. Rather, these embodiments are provided to describe the present invention in detail to the extent that a person skilled in the art to which the invention pertains can enforce the technical concepts of the present invention.

It is to be understood that embodiments of the present invention are not limited to the particulars shown in the drawings, that the drawings are not necessarily to scale, and, in some instances, proportions may have been exaggerated in order to more clearly depict certain features of the invention. While particular terminology is used, it is to be appreciated that the terminology used is for describing particular embodiments only and is not intended to limit the scope of the present invention.

It will be further understood that when an element is referred to as being “connected to”, or “coupled to” another element, it may be directly on, connected to, or coupled to the other element, or one or more intervening elements may be present. In addition, it is will also be understood that when an element is referred to as being “between” two elements, it may be the only element between the two elements, or one or more intervening elements may also be present.

The phrase “at least one of . . . and . . . ,” when used herein with a list of items, means a single item from the list or any combination of items in the list. For example, “at least one of A, B, and C” means, only A, or only B, or only C, or any combination of A, B, and C.

As used herein, singular forms are intended to include the plural forms as well, unless the context clearly indicates otherwise. It will be further understood that the terms “comprises,” “comprising,” “includes,” and “including” when used in this specification, specify the presence of the stated elements and do not preclude the presence or addition of one or more other elements. As used herein, the term “and/or” includes any and all combinations of one or more of the associated listed items.

Unless otherwise defined, all terms including technical and scientific terms used herein have the same meaning as commonly understood by one of ordinary skill in the art to which the present invention belongs in view of the present disclosure. It will be further understood that terms, such as those defined in commonly used dictionaries, should be interpreted as having a meaning that is consistent with their meaning in the context of the present disclosure and the relevant art and will not be interpreted in an idealized or overly formal sense unless expressly so defined herein.

In the following description, numerous specific details are set forth in order to provide a thorough understanding of the present invention. The present invention may be practiced without some or all of these specific details. In other instances, well-known process structures and/or processes have not been described in detail in order not to unnecessarily obscure the present invention.

It is also noted, that in some instances, as would be apparent to those skilled in the relevant art, an element also referred to as a feature described in connection with one embodiment may be used singly or in combination with other elements of another embodiment, unless specifically indicated otherwise.

Hereinafter, the various embodiments of the present invention will be described in detail with reference to the attached drawings.

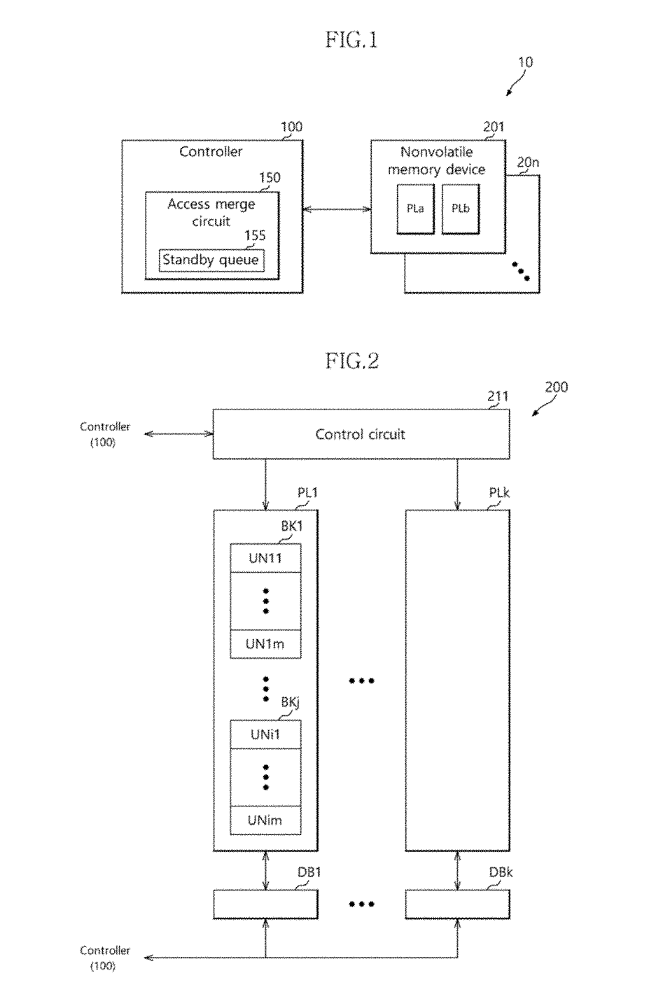

FIG. 1 is a block diagram illustrating an example of a memory system 10 in accordance with an embodiment.

The memory system 10 may be configured to store the data provided from an external host device, in response to a write request from the host device. Also, the memory system 10 may be configured to provide stored data to the host device, in response to a read request from the host device.

The memory system 10 may be configured by a Personal Computer Memory Card International Association (PCMCIA) card, a Compact Flash (CF) card, a smart media card, a memory stick, various multimedia cards (MMC, eMMC, RS-MMC, and MMC-Micro), various secure digital cards (SD, Mini-SD, and Micro-SD), a Universal Flash Storage (UFS), a Solid State Drive (SSD) and the like.

The memory system 10 may include a controller 100 and a plurality of nonvolatile memory devices 201 to 20n.

The controller 100 may control general operations of the memory system 10. The controller 100 may store data in the nonvolatile memory devices 201 to 20n in response to a write request transmitted from the host device, and may read data stored in the nonvolatile memory devices 201 to 20n and output read data to the host device in response to a read request transmitted from the host device.

The controller 100 may include an access merge circuit 150. The access merge circuit 150 may determine whether a first access operation to, for example, the nonvolatile memory device 201 is a random access operation. Depending on a result of determination, the access merge circuit 150 may access at least one first target plane PLa of the first access operation. In this regard, the controller 100 may simultaneously access the first target plane PLa and at least one second target plane PLb included in the same nonvolatile memory device 201.

In this disclosure, a process of simultaneously accessing a first target plane and at least one second target plane included in the same nonvolatile memory device may be referred to as an access merge process. The access operation to a target plane may be a read operation to the target plane. For the access merge process, pieces of information on the access operations to the target planes may be queued. In this disclosure, a target plane of a first access operation may be referred to as a first target plane, and a target plane of a second access operation may be referred to as a second target plane, in various exemplary embodiments. The access merge circuit 150 may include a standby queue 155 configured to queue the pieces of information on standing-by access operations, one or more of which may be detected as the second access operations and merged with the first access operation for the access merge process.

The access merge circuit 150 may search at least one second access operation that may be merged with the first access operation among the standing-by access operations queued in the standby queue 155 by searching one or more target planes of the standing-by access operations queued in the standby queue 155 which can be put in the access merge process as the second target planes.

When detecting one or more second target planes, the access merge circuit 150 may determine that the standing-by second access operations of the detected second target planes can be merged with the first access operation to the first target plane PLa.

In accordance with an embodiment of the present disclosure, the second target plane, which can be put in the access merge process, may be different from the first target plane while being included in the same nonvolatile memory device. The access merge circuit 150 may determine, when the target plane of a certain standing-by access operation is included in the nonvolatile memory device 201 and is different from the first target plane PLa, that the corresponding standing-by access operation may be merged with the first access operation.

When a second access operation is searched, the access merge circuit 150 may set the target plane of the second access operation as the second target plane PLb. When a second access operation is not searched, the access merge circuit 150 may keep the first access operation queued in the standby queue 155. That is, the access merge circuit 150 may merge and perform at once a first access operation and a second access operation requested for different causes, respectively.

In accordance with an embodiment of the present disclosure, each of the nonvolatile memory devices 201 to 20n may access a predetermined number of planes included therein at a substantially the same time. In this disclosure, a unit of the predetermined number of planes accessible at a substantially the same time by a nonvolatile memory device may be referred to as a simultaneously accessible plane unit. Basically, the simultaneously accessible plane unit may be a unit of the access merge process. For example, when a number of planes of the simultaneously accessible plane unit is 2, the access merge circuit 150 may put the first target plane PLa and the second target lane PLb in the access merge process. For example, when a number of planes of the simultaneously accessible plane unit is 4, the access merge circuit 150 may keep the first access operation and the second access operation queued in the standby queue 155 without putting them in the access merge process.

When the first target plane PLa and the second target plane PLb form the simultaneously accessible plane unit (i.e., when a number of planes of the simultaneously accessible plane unit is 2), the access merge circuit 150 may simultaneously access the first target plane PLa and the second target plane PLb (i.e., the access merge circuit 150 may put the first target plane PLa and the second target lane PLb in the access merge process). When the first target plane PLa and the second target plane PLb do not form the simultaneously accessible plane unit (i.e., when a number of planes of the simultaneously accessible plane unit is 4), the access merge circuit 150 may keep the first access operation and the second access operation queued in the standby queue 155.

According to an embodiment, when the first target plane PLa and the second target plane PLb do not form the simultaneously accessible plane unit, the access merge circuit 150 may determine, based on the standby time of the second access operation queued in the standby queue 155, whether or not the second access operation still can stay in the standby queue 155.

For example, when the standby time of the second access operation is shorter than a predetermined threshold time, the access merge circuit 150 may determine that the second access operation still can stay in the standby queue 155. When the second access operation still can stay in the standby queue 155, the access merge circuit 150 may keep the first access operation and the second access operation queued in the standby queue 155. However, when the second access operation cannot stay in the standby queue 155 because the standby time of the second access operation is about to reach the predetermined threshold time, the access merge circuit 150 may merge and perform the access merge process with the first access operation and the second access operation even though the simultaneously accessible plane unit is not formed.

As described above, the access merge circuit 150 may perform access operations queued in the standby queue 155 based on the standby time of each of the standing-by access operations and the threshold time. For example, when the standby time of an access operation queued in the standby queue 155 exceeds the threshold time, the access merge circuit 150 may perform the queued access operation in the standby queue 155 through the access merge process even when the target plane of the queued access operation does not form the simultaneously accessible plane unit.

The access merge circuit 150 may perform the random access operation through the access merge process. Meanwhile, when the access operation is determined as a sequential access operation to one or more nonvolatile memory devices, the access merge circuit 150 may group the plurality of target memory units of the access operation into one or more groups. In an embodiment, the memory unit may correspond to a single plane.

The access merge circuit 150 may group the plurality of target memory units by the simultaneously accessible plane unit. The access merge circuit 150 may merge access operations of one or more target memory units, which are the remaining ones after grouping the target memory units by the simultaneously accessible plane unit, with reference to the standby times thereof as described above.

In order to quickly process the sequential access operation, according to an embodiment, the access merge circuit 150 may immediately perform the sequential access operation without keeping it queued in the standby queue 155, even though some of target memory units of the sequential access operation do not form the simultaneously accessible plane unit and any standing-by access operation fit to the access merge process is not searched in the standby queue 155.

The plurality of nonvolatile memory devices 201 to 20n may store data transmitted from the controller 100 and may read stored data and transmit read data to the controller 100, according to control of the controller 100. Each of the nonvolatile memory devices 201 and 20n may include a plurality of planes which are simultaneously accessible. When making descriptions by taking the nonvolatile memory device 201 as an example, the nonvolatile memory device 201 may include the first and second target planes PLa and PLb. The nonvolatile memory device 201 may simultaneously read the data stored in a first target memory unit of the first target plane PLa and the data stored in a second target memory unit of the second target plane PLb according to control of the controller 100. In this regard, as will be described later, the position of the second target memory unit may be independent of the position of the first target memory unit.

A nonvolatile memory device may include a flash memory, such as a NAND flash or a NOR flash, a Ferroelectrics Random Access Memory (FeRAM), a Phase-Change Random Access Memory (PCRAM), a Magnetoresistive Random Access Memory (MRAM), a Resistive Random Access Memory (ReRAM), and the like.

FIG. 2 is a block diagram illustrating an example of the detailed configuration of a nonvolatile memory device 200. The nonvolatile memory devices 201 to 20n of FIG. 1 may be configured and operate in substantially the same manner as the nonvolatile memory device 200.

Referring to FIG. 2, the nonvolatile memory device 200 may include a control circuit 211, a plurality of data buffers DB1 to DBk and a plurality of planes PL1 to PLk. The control circuit 211 may perform a write operation to store data in the plurality of planes PL1 to PLk, according to control of the controller 100. Also, the control circuit 211 may perform an access operation to read data from the plurality of planes PL1 to PLk, according to control of the controller 100. In order for the write operation and the access operation, the control circuit 211 may simultaneously select one or more target planes among the plurality of planes PL1 to PLk, and may access concrete positions designated by the controller 100, that is, target memory units, in the respective selected target planes.

The plurality of data buffers DB1 to DBk may correspond to the plurality of planes PL1 to PLk, respectively, and may temporarily store data to be transmitted between the plurality of planes PL1 to PLk and the controller 100. In detail, when a write operation is performed, each of the data buffers DB1 to DBk may receive, from the controller 100, and store data to be stored in a corresponding plane. When an access operation is performed, each of the data buffers DB1 to DBk may store the data read from a corresponding plane and transmit the data to the controller 100.

Each of the data buffers DB1 to DBk may be shared by a plurality of memory blocks included in a corresponding plane. For example, the data buffer DB1 may temporarily store data to be transmitted between memory blocks BK1 to BKi included in the corresponding plane PL1 and the controller 100.

The planes PL1 to PLk may store the data transmitted from the data buffers DB1 to DBk. Each of the planes PL1 to PLk may include a plurality of memory blocks. When making descriptions by taking the plane PL1 as an example, the plane PL1 may include the plurality of memory blocks BK1 to BKi. The memory blocks BK1 to BKi may share the corresponding data buffer DB1.

A memory block may be a memory unit by which an erase operation is performed. In other words, when performing an erase operation for a target memory block, the nonvolatile memory device 200 may simultaneously erase the data stored in the target memory block.

The respective memory blocks BK1 to BKi may be configured in substantially the same way with one another. When making descriptions by taking the memory block BK1 as an example, the memory block BK1 may include a plurality of memory units UN11 to UN1m.

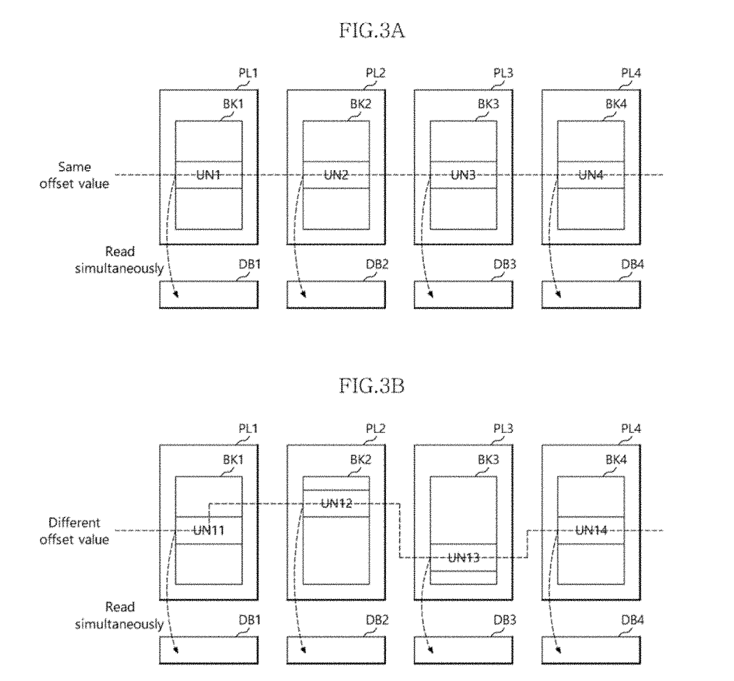

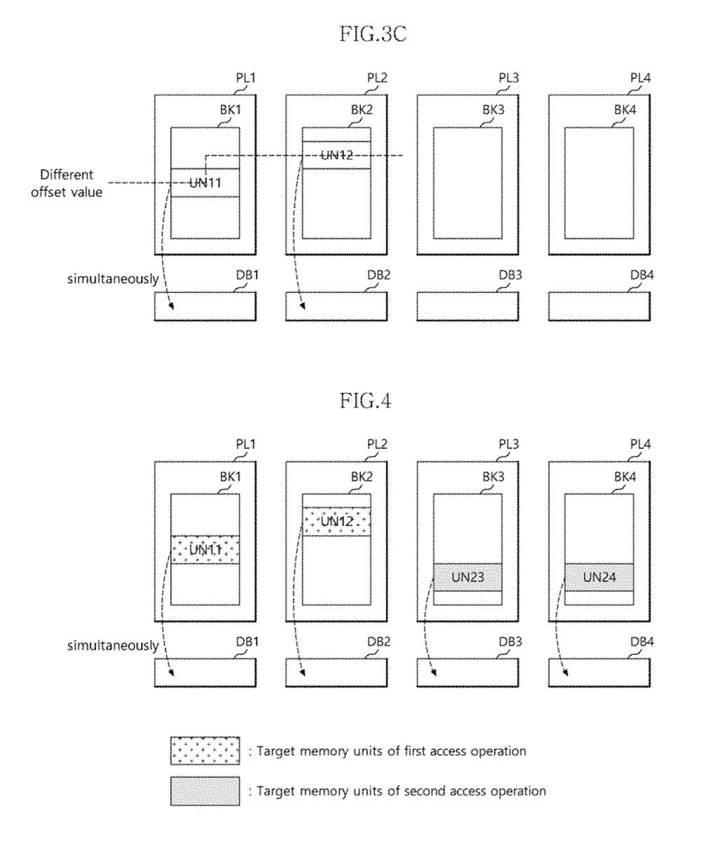

A memory unit may be a memory unit by which an access operation is performed in each of the planes PL1 to PLk. In other words, when performing an access operation, the nonvolatile memory device 200 may select one or more target planes among the planes PL1 to PLk, and may read the data stored in the target memory units of the respective selected target planes. As will be described later with reference to FIG. 3A, the nonvolatile memory device 200 may simultaneously read data from the target memory units of at least two target planes. The data read from the target memory units may be stored in respective corresponding data buffers.

The memory units UN11 to UN1m may correspond to predetermined offset values, respectively, by the unit of memory block. Each of the memory blocks BK1 to BKi may include memory units of the predetermined offset values. For example, when “m” number of memory units are included in each memory block, each of the memory blocks BK1 to BKi may include memory units corresponding to offset values “1” to “m.” Offset values may be the addresses of memory units. Offset values may define the positions of memory units in a memory block. While memory units having the same offset value may be positioned at the same position in memory blocks, the embodiment of the present disclosure is not limited thereto. Summarizing these, the controller 100 may specify, as a target, and access a certain memory unit by designating the address of a plane, the address of a memory block and a specified offset value.

Further, each of the planes PL1 to PLk may be constructed by a plurality of memory cells. Each of the memory cells may store at least one data bit. Depending on the number of data bits to be stored in each memory cell, a group of one or more memory units may correspond to a single word line, and may correspond to a group of memory cells coupled together to the corresponding word line. The data stored in a certain group of memory units may be ones stored in a corresponding group of memory cells. In order to access a target memory unit, the nonvolatile memory device 200 may access a corresponding group of memory cells by driving a corresponding word line. The memory unit may be a page unit.

When 1 bit is stored in each memory cell, a word line or a group of memory cells may correspond to one memory unit. When 2 bits, that is, LSB (least significant bit) and MSB (most significant bit) data are stored in each memory cell, a word line or a group of memory cells may correspond to two memory units in which LSB and MSB data are stored, respectively. When 3 bits, that is, LSB, CSB (central significant bit) and MSB data are stored in each memory cell, a word line or a group of memory cells may correspond to three memory units in which LSB, CSB and MSB data are stored, respectively.

FIG. 3A is an example of a diagram to assist in the description of a method for the nonvolatile memory device 200 of FIG. 2 to perform an access operation for target planes PL1 to PL4. Hereunder, the nonvolatile memory device 200 includes four planes PL1 to PL4 for example.

The target planes PL1 to PL4 may include target memory blocks BK1, BK2, BK3 and BK4, respectively, which include target memory units UN1, UN2, UN3 and UN4 for the access operation. Namely, one memory block may be selected as a target in each plane, and one memory unit may be selected as a target in the corresponding memory block. The target memory units UN1, UN2, UN3 and UN4 may be simultaneously accessed. That is, when the access operation is performed, the data stored in the target memory units UN1, UN2, UN3 and UN4 may be simultaneously read and be stored in data buffers DB1 to DB4.

The target memory units UN1, UN2, UN3 and UN4 may have the same offset value. When the target memory units UN1, UN2, UN3 and UN4 have the same offset value, the target memory units UN1, UN2, UN3 and UN4 may be present at the same position in the target memory blocks BK1, BK2, BK3 and BK4.

However, as will be described below, according to an embodiment, target memory units for an access operation may have different offset values.

FIG. 3B is an example of a diagram to assist in the description of a method for the nonvolatile memory device 200 of FIG. 2 to perform an access operation for target planes PL1 to PL4.

Referring to FIG. 3B, unlike FIG. 3A, target memory units UN11, UN12, UN13 and UN14 of the target planes PL1 to PL4 may have different offset values. When the target memory units UN11, UN12, UN13 and UN14 have different offset values, the target memory units UN11, UN12, UN13 and UN14 may be present at different positions in target memory blocks BK1, BK2, BK3 and BK4. The nonvolatile memory device 200 may simultaneously access the target memory units UN11, UN12, UN13 and UN14. That is, when the access operation is performed, the data stored in the target memory units UN11, UN12, UN13 and UN14 may be simultaneously read and be stored in data buffers DB1 to DB4.

FIG. 3C is an example of a diagram to assist in the description of a method for the nonvolatile memory device 200 of FIG. 2 to perform an access operation for target planes PL1 and PL2.

Referring to FIG. 3C, unlike FIGS. 3A and 3B, the access operation of the nonvolatile memory device 200 may be performed for only a part of the planes PL1 to PL4. For example, among the planes PL1 to PL4, the planes PL1 and PL2 may be selected as target planes for the access operation. Target memory units UN11 and UN12 included in target memory blocks BK1 and BK2 of the target planes PL1 and PL2 may be selected for the access operation. The nonvolatile memory device 200 may simultaneously access the target memory units UN11 and UN12. That is, when the access operation is performed, the data stored in the target memory units UN11 and UN12 may be simultaneously read and be stored in data buffers DB1 and DB2.

Summarizing these, the nonvolatile memory device 200 in accordance with the embodiment of the present disclosure may perform an access operation to target memory units having the same offset value or different offset values in one or more planes. The target memory units may be simultaneously accessed. Accordingly, better performance may be achieved in the case in which access operations are performed to different planes by being merged than the case in which access operations are performed to different planes separately.

For example, when read commands for different planes are generated with time intervals, a read command generated first may be queued and be performed at once by being merged with a read command generated later. Merging two or more access operations may correspond to generating one read command such that the target memory units of different planes are simultaneously accessed, when the access operations for the target memory units are scheduled to be performed with time intervals. In order to merge access operations, they should have the same nonvolatile memory device as a target memory device and should have target memory units of different planes. Access operations that can be merged may be access operations to be performed by the controller 100 according to an access request from the host device or may be access operations to be performed to manage the memory system 10. The access operations to be performed to manage the memory system 10 may be access operations to be performed in, for example, a garbage collection operation and a wear leveling operation.

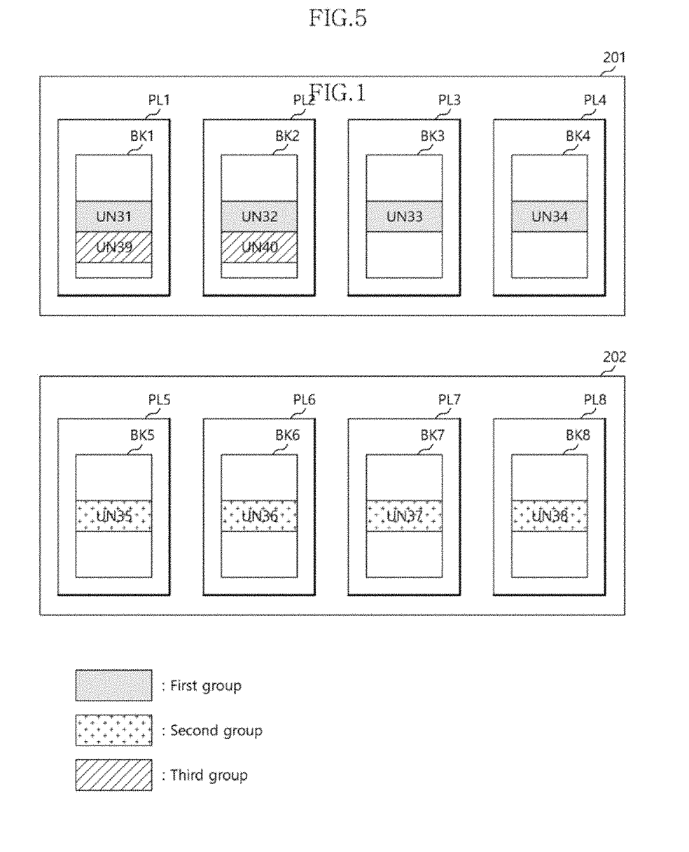

FIG. 4 is an example of a diagram to assist in the description of a method for the access merge circuit 150 to merge access requests.

Referring to FIG. 4, a first access operation for target memory units UN11 and UN12 may be one to be performed according to an access request received from the host device.

The access merge circuit 150 may determine whether target planes PL1 and PL2 according to the access request form a simultaneously accessible plane unit. The simultaneously accessible plane unit may be formed by a predetermined number of planes which can be simultaneously accessed by the nonvolatile memory device 200. For example, the simultaneously accessible plane unit may be formed by planes PL1 to PL4.

The access merge circuit 150 may determine that the target planes PL1 and PL2 do not form the simultaneously accessible plane unit, and may determine to merge the access operations for the target memory units UN11 and UN12 with another access operation queued in the standby queue 155 in order to form the simultaneously accessible plane unit with the target planes PL1 and PL2 and other target planes related to the another access operation queued in the standby queue 155.

For example, the access merge circuit 150 may select a second access operation to target memory units UN23 and UN24 of the planes PL3 and PL4 among standing-by access operations queued in the standby queue 155. In other words, the access merge circuit 150 may select the second access operation to different target planes (i.e., the planes PL3 and PL4) included in the same nonvolatile memory device 200 when compared to the first access operation to the target planes (i.e., the planes PL1 and PL2) among the standing-by access operations queued in the standby queue 155. The access merge circuit 150 may merge the first access operation and second access operation for the access merge process. The access merge circuit 150 may simultaneously perform the first access operation and the second access operation by simultaneously accessing the target memory units UN11, UN12, UN23 and UN24 of the target planes PL1 to PL4. The data stored in the target memory units UN11, UN12, UN23 and UN24 may be simultaneously accessed.

The access merge circuit 150 may select the second access operation for the access merge process without reference to the offset values of the target memory units UN11, UN12, UN23 and UN24. This is because, as described above with reference to FIG. 3B, the nonvolatile memory device 200 may simultaneously access target memory units having different offset values in the planes PL1 to PL4. Therefore, the offset values of the target memory units UN11, UN12, UN23 and UN24 of the first and second access operations that are merged with each other are independent of one another. In other words, the positions of the target memory units UN11, UN12, UN23 and UN24 of the first and second access operations are independent of one another.

While FIG. 4 illustrates that one second access operation is selected among the standing-by access operations, it is to be noted that a plurality of access operations may be merged.

When a second access operation for the access merge process is not searched among the standing-by access operations, the access merge circuit 150 may keep the first access operation queued in the standby queue 155.

In an embodiment, the access merge circuit 150 may merge access operations for the access merge process only when the target planes of the access operations form the simultaneously accessible plane unit, that is, the planes PL1 to PL4. When the target planes of access operations do not form the simultaneously accessible plane unit, the access merge circuit 150 may not merge the corresponding access operations and may keep all the access operations queued in the standby queue 155.

In an embodiment, the access merge circuit 150 may perform standing-by access operations through the access merge process based on the respective standby times of the standing-by access operations queued in the standby queue 155. Namely, in order to prevent access operations from being queued in the standby queue 155 without being processed even when the standby time of a standing-by access operation exceeds a threshold time, the access merge circuit 150 may perform a standing-by access request solely or through the access merge process. When the standby time of a standing-by access operation does not exceed the threshold time, the access merge circuit 150 may keep the standing-by access operation queued in the standby queue 155.

Thus, even though the target planes do not form the simultaneously accessible plane unit, the access merge circuit 150 may merge and perform the access operations corresponding to the target planes in the case in which the standby time of the access operations exceeds the threshold time.

FIG. 5 is an example of a diagram to assist in the description of a method for the access merge circuit 150 to perform a sequential access operation.

First, an access request transmitted from the host device may be a random access request or a sequential access request. The controller 100 may perform a random access operation according to the random access request, and may perform a sequential access operation according to the sequential access request. The random access operation may be one to access one target plane of a certain nonvolatile memory device. The sequential access operation may be one to access a plurality of target planes of at least two nonvolatile memory devices. When the sequential access operation is performed, the target memory units included in target planes may correspond to consecutive addresses.

Therefore, depending on whether an access operation according to an access request transmitted from the host device is a random access operation or a sequential access operation, the access merge circuit 150 may apply the access merge process to the access operation. In detail, when performing a random access operation, the access merge circuit 150 may immediately process a target plane for the access merge process. That is, since the target plane of the random access operation does not form the simultaneously accessible plane unit, the access merge process is required.

In the meantime, when performing a sequential access operation for, for example, nonvolatile memory devices 201 and 202 as shown in FIG. 5, the access merge circuit 150 may group a plurality of target memory units UN31 to UN40 of the sequential access operation into one or more groups by the simultaneously accessible plane unit. For example, the target memory units UN31 to UN34 may be grouped as a first group because target planes PL1 to PL4 of the target memory units UN31 to UN34 form the simultaneously accessible plane unit, the target memory units UN35 to UN38 may be grouped as a second group because target planes PL5 to PL8 of the target memory units UN35 to UN38 also form the simultaneously accessible plane unit, and the remaining target memory units UN39 and UN40, which cannot form the simultaneously accessible plane unit, may become a third group.

In an embodiment, the access merge circuit 150 may merge the access operation for the target memory units UN39 and UN40 of the target planes PL1 and PL2 with another standing-by access operation to other target memory units included in the planes PL3 and PL4 in order to form the simultaneously accessible plane unit.

In another embodiment, in order for the performance of the sequential access operation, the access merge circuit 150 may immediately perform the sequential access operation without keeping the remaining target memory units UN39 and UN40 of the third group queued even though any further standing-by access operation is not searched for the access merge process with the remaining target memory units UN39 and UN40 of the third group.

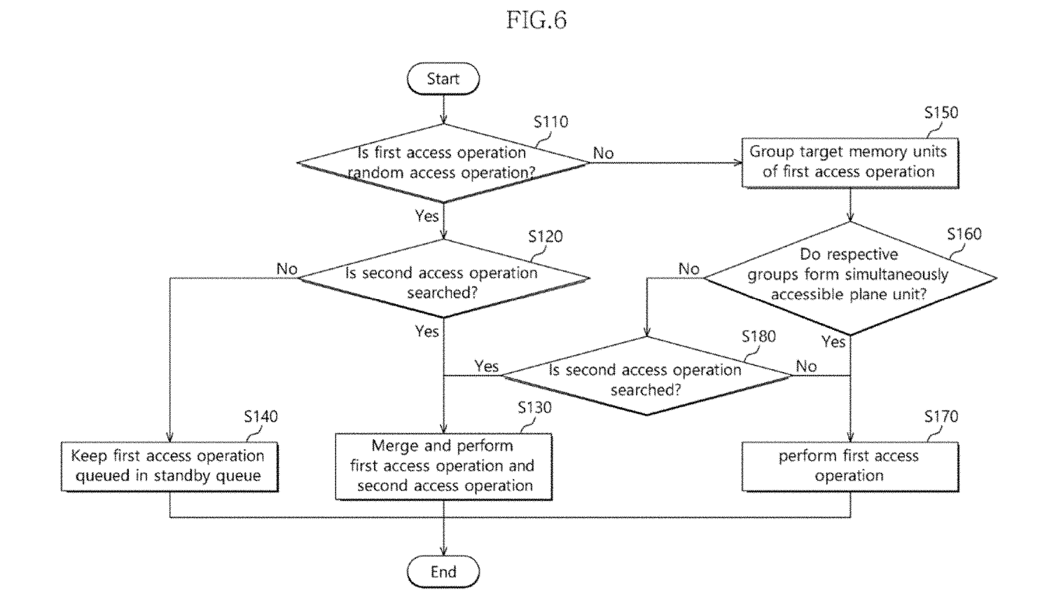

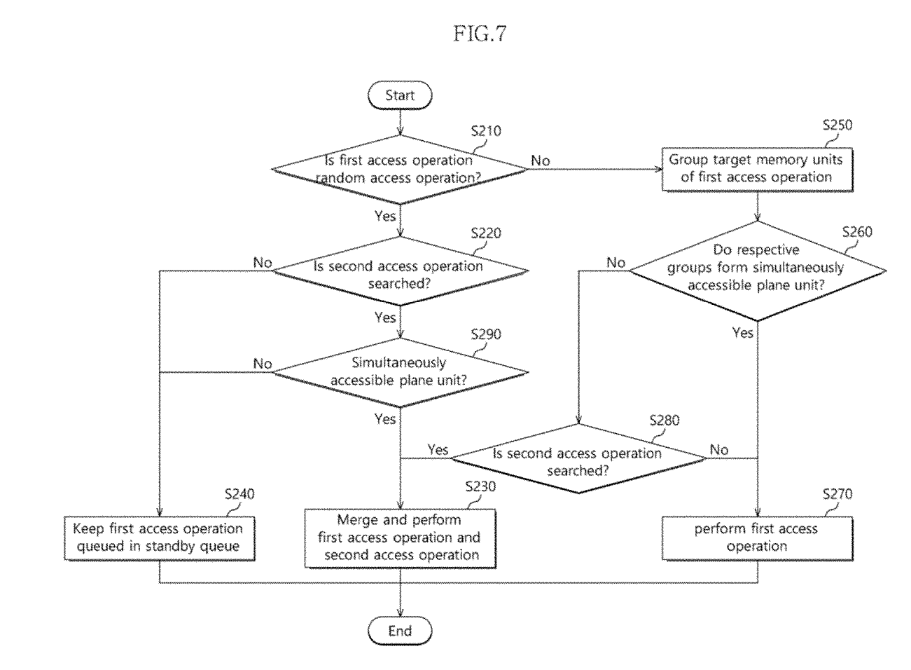

FIG. 6 is an example of a flow chart to assist in the description of a method for operating the memory system 10 of FIG. 1, in accordance with an embodiment.

Referring to FIG. 6, at step S110, the access merge circuit 150 may determine whether or not a first access operation for the nonvolatile memory devices 201 to 20n is a random access operation. When the first access operation is a random access operation, the process may proceed to step S120.

At the step S120, the access merge circuit 150 may search at least one second access operation that can be merged with the first access operation for the access merge process, among the access operations queued in the standby queue 155. The access merge circuit 150 may determine, when a nonvolatile memory device may simultaneously access at least one first target plane of the first access operation and at least one target plane of a certain standing-by access operation, so that the corresponding standing-by access operation can be merged as the second access operation with the first access operation for the access merge process. When the second access operation is searched, the process may proceed to step S130.

At the step S130, the access merge circuit 150 may merge and perform the first access operation and second access operation through the access merge process. In other words, the access merge circuit 150 may simultaneously access the first target plane of the first access operation and the second target plane of the second access operation.

However, at the step S120, when the second access operation is not searched, the process may proceed to step S140.

At the step S140, the access merge circuit 150 may keep the first access operation queued in the standby queue 155.

At the step S110, when the first access operation is not a random access operation, that is, when the first access operation is a sequential access operation, the process may proceed to step S150.

At the step S150, the access merge circuit 150 may group the plurality of target memory units of the first access operation into one or more groups by the simultaneously accessible plane unit.

At step S160, the access merge circuit 150 may determine whether respective groups form the simultaneously accessible plane unit. The simultaneously accessible plane unit may be formed by a predetermined number of planes which may be simultaneously accessed by a nonvolatile memory device. When the respective groups form the simultaneously accessible plane unit, the process may proceed to step S170.

At the step S170, the access merge circuit 150 may perform the first access operation solely.

However, at the step S160, when the simultaneously accessible plane unit is not formed in at least one of the groups, the process may proceed to step S180.

At the step S180, the access merge circuit 150 may search at least one second access operation that can be merged with the first access operation for the access merge process, among the access operations queued in the standby queue 155. When a second access operation is not searched, the process may proceed to the step S170. That is, since the sequential access operation needs to be quickly performed, the access merge circuit 150 may perform the first access operation even though one or more of the target memory units of the first access operation do not form the simultaneously accessible plane unit.

However, when a second access operation is searched, the process may proceed to the step S130. In other words, at the step S130, the access merge circuit 150 may merge and perform the first access operation and the second access operation through the access merge process. Namely, the access merge circuit 150 may simultaneously access the target planes of a group which does not form the simultaneously accessible plane unit, among the target planes of the first access operation, and the second target plane of the second access operation.

FIG. 7 is an example of a flow chart to assist in the description of a method for operating the memory system 10 of FIG. 1, in accordance with an embodiment. In the operating method of FIG. 7, since steps S210 to S280 are substantially the same as the steps S110 to S180 of FIG. 6, detailed descriptions thereof will be omitted herein. When compared to the operating method of FIG. 6, the operating method of FIG. 7 may further include step S290.

At the step S220, when a second access operation is not searched, the process may proceed to the step S290.

At the step S290, the access merge circuit 150 may determine whether at least one first target plane of the first access operation and at least one second target plane of the second access operation form the simultaneously accessible plane unit. When the first target plane and the second target plane form the simultaneously accessible plane unit, the process may proceed to the step S230. That is, at the step S230, the access merge circuit 150 may merge and perform the first access operation and second access operation through the access merge process.

However, at the step S290, when the first target plane and the second target plane do not form the simultaneously accessible plane unit, the process may proceed to the step S240. In other words, at the step S240, the access merge circuit 150 may keep the first access operation queued in the standby queue 155. At this time, the second access operation may also be continuously queued in the standby queue 155.

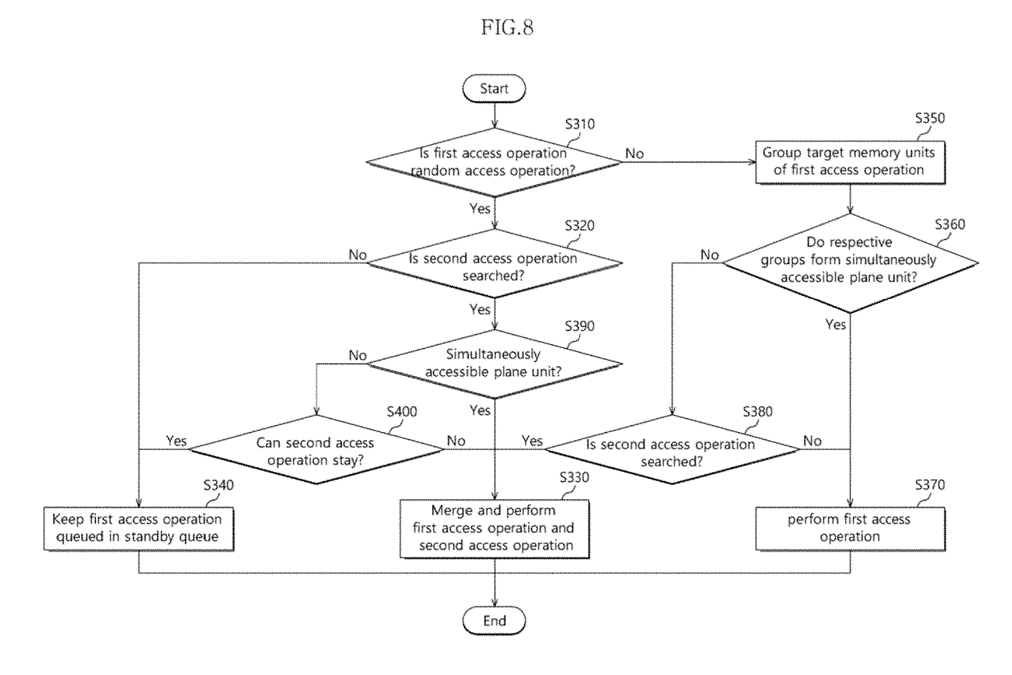

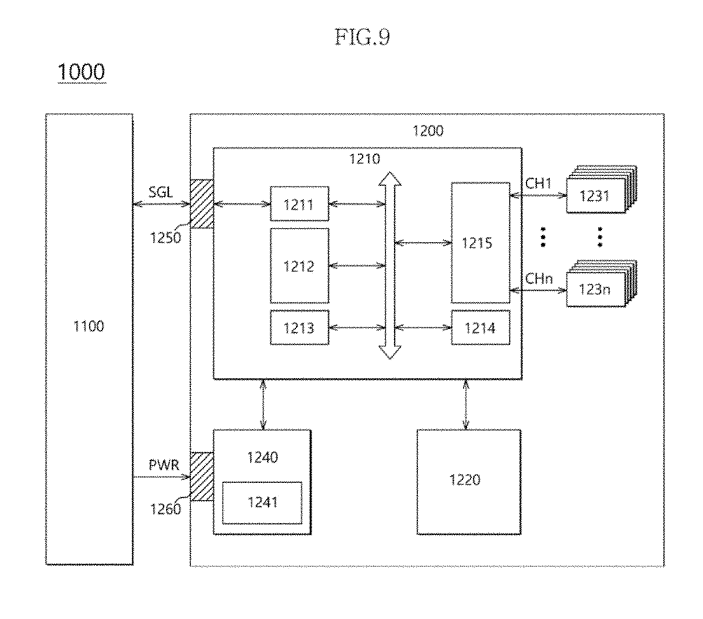

FIG. 8 is an example of a flow chart to assist in the description of a method for operating the memory system 10 of FIG. 1, in accordance with an embodiment. In the operating method of FIG. 8, since steps S310 to S390 are substantially the same as the steps S210 to S290 of FIG. 7, detailed descriptions thereof will be omitted herein. When compared to the operating method of FIG. 7, the operating method of FIG. 8 may further include step S400.

At the step S390, when at least one first target plane of the first access operation and at least one second target plane of the second access operation do not form the simultaneously accessible plane unit, the process may proceed to the step S400.

At the step S400, the access merge circuit 150 may determine, based on the standby time of the second access operation queued in the standby queue 155, whether or not the second access operation still can stay in the standby queue 155. For example, when the standby time of the second access operation is shorter than a predetermined threshold time, the access merge circuit 150 may determine that the second access operation still can stay in the standby queue 155. When the second access operation stays in the standby queue 155, the process may proceed to the step S340. Namely, at the step S340, the access merge circuit 150 may keep the first access operation queued in the standby queue 155. At this time, the second access operation may also be queued in the standby queue 155.

However, at the step S400, when the second access operation cannot stay in the standby queue 155 because the standby time of the second access operation is about to reach the predetermined threshold time, the process may proceed to the step S330. That is, at the step S330, the access merge circuit 150 may merge and perform the first access operation and second access operation through the access merge process.

FIG. 9 is a diagram illustrating a data processing system 1000 including a solid state drive (SSD) 1200 in accordance with an embodiment. Referring to FIG. 9, the data processing system 1000 may include a host device 1100 and the SSD 1200.

The SSD 1200 may include a controller 1210, a buffer memory device 1220, a plurality of nonvolatile memory devices 1231 to 123n, a power supply 1240, a signal connector 1250, and a power connector 1260.

The controller 1210 may control general operations of the SSD 1200. The controller 1210 may include a host interface unit 1211, a control unit 1212, a random access memory 1213, an error correction code (ECC) unit 1214, and a memory interface unit 1215.

The host interface unit 1211 may exchange a signal SGL with the host device 1100 through the signal connector 1250. The signal SGL may include a command, an address, data, and so forth. The host interface unit 1211 may interface the host device 1100 and the SSD 1200 according to the protocol of the host device 1100. For example, the host interface unit 1211 may communicate with the host device 1100 through any one of standard interface protocols such as secure digital, universal serial bus (USB), multimedia card (MMC), embedded MMC (eMMC), personal computer memory card international association (PCMCIA), parallel advanced technology attachment (PATA), serial advanced technology attachment (SATA), small computer system interface (SCSI), serial attached SCSI (SAS), peripheral component interconnection (PCI), PCI express (PCI-E) and universal flash storage (UFS).

The control unit 1212 may analyze and process the signal SGL received from the host device 1100. The control unit 1212 may control operations of internal function blocks according to a firmware or a software for driving the SSD 1200. The random access memory 1213 may be used as a working memory for driving such a firmware or software.

The ECC unit 1214 may generate the parity data of data to be transmitted to at least one of the nonvolatile memory devices 1231 to 123n. The generated parity data may be stored together with the data in the nonvolatile memory devices 1231 to 123n. The ECC unit 1214 may detect an error of the data read from at least one of the nonvolatile memory devices 1231 to 123n, based on the parity data. If a detected error is within a correctable range, the ECC unit 1214 may correct the detected error.

The memory interface unit 1215 may provide control signals such as commands and addresses to at least one of the nonvolatile memory devices 1231 to 123n, according to control of the control unit 1212. Moreover, the memory interface unit 1215 may exchange data with at least one of the nonvolatile memory devices 1231 to 123n, according to control of the control unit 1212. For example, the memory interface unit 1215 may provide the data stored in the buffer memory device 1220, to at least one of the nonvolatile memory devices 1231 to 123n, or provide the data read from at least one of the nonvolatile memory devices 1231 to 123n, to the buffer memory device 1220.

The buffer memory device 1220 may temporarily store data to be stored in at least one of the nonvolatile memory devices 1231 to 123n. Further, the buffer memory device 1220 may temporarily store the data read from at least one of the nonvolatile memory devices 1231 to 123n. The data temporarily stored in the buffer memory device 1220 may be transmitted to the host device 1100 or at least one of the nonvolatile memory devices 1231 to 123n according to control of the controller 1210.

The nonvolatile memory devices 1231 to 123n may be used as storage media of the SSD 1200. The nonvolatile memory devices 1231 to 123n may be coupled with the controller 1210 through a plurality of channels CH1 to CHn, respectively. One or more nonvolatile memory devices may be coupled to one channel. The nonvolatile memory devices coupled to each channel may be coupled to the same signal bus and data bus.

The power supply 1240 may provide power PWR inputted through the power connector 1260, to the inside of the SSD 1200. The power supply 1240 may include an auxiliary power supply 1241. The auxiliary power supply 1241 may supply power to allow the SSD 1200 to be normally terminated when a sudden power-off occurs. The auxiliary power supply 1241 may include large capacity capacitors.

The signal connector 1250 may be configured by various types of connectors depending on an interface scheme between the host device 1100 and the SSD 1200.

The power connector 1260 may be configured by various types of connectors depending on a power supply scheme of the host device 1100.

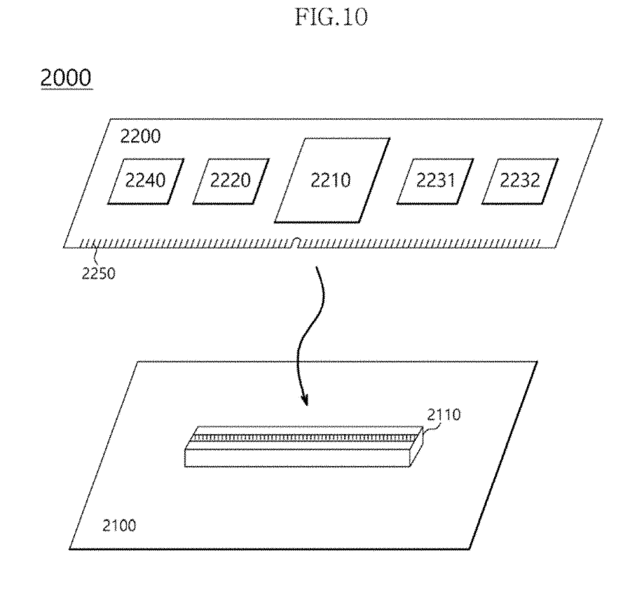

FIG. 10 is a diagram illustrating a data processing system 2000 including a memory system 2200 in accordance with an embodiment. Referring to FIG. 10, the data processing system 2000 may include a host device 2100 and the memory system 2200.

The host device 2100 may be configured in the form of a board such as a printed circuit board. Although not shown, the host device 2100 may include internal function blocks for performing the function of a host device.

The host device 2100 may include a connection terminal 2110 such as a socket, a slot or a connector. The memory system 2200 may be mounted to the connection terminal 2110.

The memory system 2200 may be configured in the form of a board such as a printed circuit board. The memory system 2200 may be referred to as a memory module or a memory card. The memory system 2200 may include a controller 2210, a buffer memory device 2220, nonvolatile memory devices 2231 and 2232, a power management integrated circuit (PMIC) 2240, and a connection terminal 2250.

The controller 2210 may control general operations of the memory system 2200. The controller 2210 may be configured in the same manner as the controller 1210 shown in FIG. 9.

The buffer memory device 2220 may temporarily store data to be stored in the nonvolatile memory devices 2231 and 2232. Further, the buffer memory device 2220 may temporarily store the data read from the nonvolatile memory devices 2231 and 2232. The data temporarily stored in the buffer memory device 2220 may be transmitted to the host device 2100 or the nonvolatile memory devices 2231 and 2232 according to control of the controller 2210.

The nonvolatile memory devices 2231 and 2232 may be used as storage media of the memory system 2200.

The PMIC 2240 may provide the power inputted through the connection terminal 2250, to the inside of the memory system 2200. The PMIC 2240 may manage the power of the memory system 2200 according to control of the controller 2210.

The connection terminal 2250 may be coupled to the connection terminal 2110 of the host device 2100. Through the connection terminal 2250, signals such as commands, addresses, data and so forth and power may be transferred between the host device 2100 and the memory system 2200. The connection terminal 2250 may be configured into various types depending on an interface scheme between the host device 2100 and the memory system 2200. The connection terminal 2250 may be disposed on any one side of the memory system 2200.

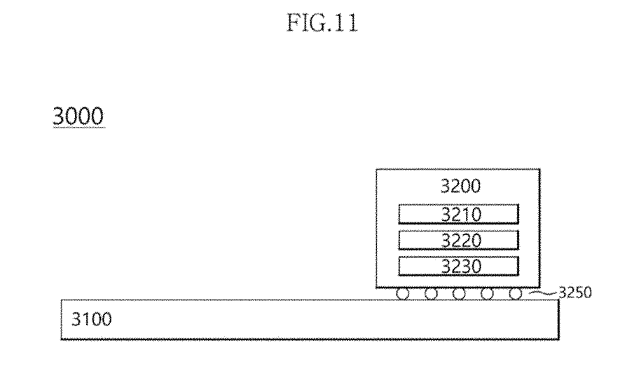

FIG. 11 is a diagram illustrating a data processing system 3000 including a memory system 3200 in accordance with an embodiment. Referring to FIG. 11, the data processing system 3000 may include a host device 3100 and the memory system 3200.

The host device 3100 may be configured in the form of a board such as a printed circuit board. Although not shown, the host device 3100 may include internal function blocks for performing the function of a host device.

The memory system 3200 may be configured in the form of a surface-mounting type package. The memory system 3200 may be mounted to the host device 3100 through solder balls 3250. The memory system 3200 may include a controller 3210, a buffer memory device 3220, and a nonvolatile memory device 3230.

The controller 3210 may control general operations of the memory system 3200. The controller 3210 may be configured in the same manner as the controller 1210 shown in FIG. 9.

The buffer memory device 3220 may temporarily store data to be stored in the nonvolatile memory device 3230. Further, the buffer memory device 3220 may temporarily store the data read from the nonvolatile memory device 3230. The data temporarily stored in the buffer memory device 3220 may be transmitted to the host device 3100 or the nonvolatile memory device 3230 according to control of the controller 3210.

The nonvolatile memory device 3230 may be used as the storage medium of the memory system 3200.

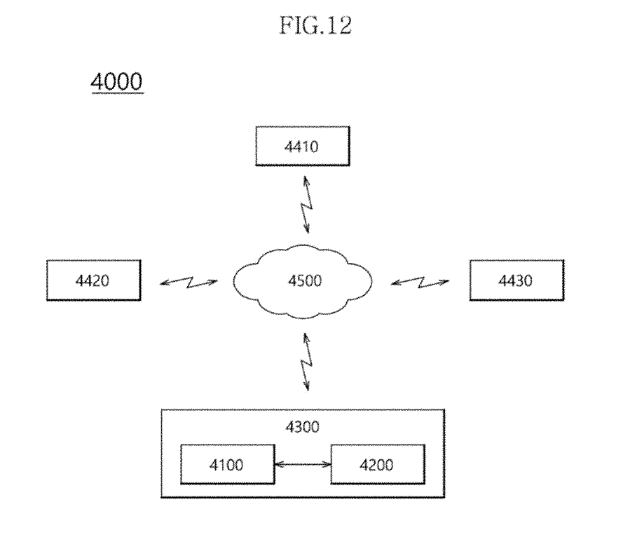

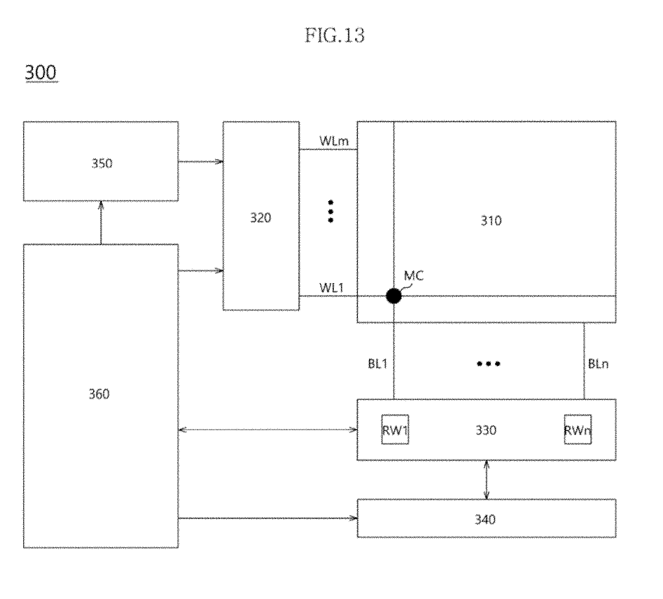

FIG. 12 is a diagram illustrating a network system 4000 including a memory system 4200 in accordance with an embodiment. Referring to FIG. 12, the network system 4000 may include a server system 4300 and a plurality of client systems 4410 to 4430 which are coupled through a network 4500.

The server system 4300 may service data in response to requests from the plurality of client systems 4410 to 4430. For example, the server system 4300 may store the data provided from the plurality of client systems 4410 to 4430. For another example, the server system 4300 may provide data to the plurality of client systems 4410 to 4430.

The server system 4300 may include a host device 4100 and the memory system 4200. The memory system 4200 may be configured by the memory system 100 shown in FIG. 1, the memory system 1200 shown in FIG. 9, the memory system 2200 shown in FIG. or the memory system 3200 shown in FIG. 11.

FIG. 13 is a block diagram illustrating a nonvolatile memory device 300 included in a memory system in accordance with an embodiment. Referring to FIG. 13, the nonvolatile memory device 300 may include a memory cell array 310, a row decoder 320, a data read/write block 330, a column decoder 340, a voltage generator 350, and a control logic 360.

The memory cell array 310 may include memory cells MC which are arranged at areas where word lines WL1 to WLm and bit lines BL1 to BLn intersect with each other.

The row decoder 320 may be coupled with the memory cell array 310 through the word lines WL1 to WLm. The row decoder 320 may operate according to control of the control logic 360. The row decoder 320 may decode an address provided from an external device (not shown). The row decoder 320 may select and drive the word lines WL1 to WLm, based on a decoding result. For instance, the row decoder 320 may provide a word line voltage provided from the voltage generator 350, to the word lines WL1 to WLm.

The data read/write block 330 may be coupled with the memory cell array 310 through the bit lines BL1 to BLn. The data read/write block 330 may include read/write circuits RW1 to RWn respectively corresponding to the bit lines BL1 to BLn. The data read/write block 330 may operate according to control of the control logic 360. The data read/write block 330 may operate as a write driver or a sense amplifier according to an operation mode. For example, the data read/write block 330 may operate as a write driver which stores data provided from the external device, in the memory cell array 310 in a write operation. For another example, the data read/write block 330 may operate as a sense amplifier which reads out data from the memory cell array 310 in an access operation.

The column decoder 340 may operate according to control of the control logic 360. The column decoder 340 may decode an address provided from the external device. The column decoder 340 may couple the read/write circuits RW1 to RWn of the data read/write block 330 respectively corresponding to the bit lines BL1 to BLn with data input/output lines or data input/output buffers, based on a decoding result.

The voltage generator 350 may generate voltages to be used in internal operations of the nonvolatile memory device 300. The voltages generated by the voltage generator 350 may be applied to the memory cells of the memory cell array 310. For example, a program voltage generated in a program operation may be applied to a word line of memory cells for which the program operation is to be performed. For another example, an erase voltage generated in an erase operation may be applied to a well area of memory cells for which the erase operation is to be performed. For still another example, a read voltage generated in an access operation may be applied to a word line of memory cells for which the access operation is to be performed.

The control logic 360 may control general operations of the nonvolatile memory device 300, based on control signals provided from the external device. For example, the control logic 360 may control operations of the nonvolatile memory device 300 such as read, write and erase operations of the nonvolatile memory device 300.

While various embodiments have been described above, it will be understood to those skilled in the art that the embodiments described are examples only. Accordingly, the memory system and the operating method thereof described herein should not be limited to the described embodiments. It will be apparent to those skilled in the art to which the present invention pertains that various other changes and modifications may be made without departing from the spirit and scope of the invention as defined in the following claims.

What is claimed is:

1. A memory system comprising:
a nonvolatile memory device including a plurality of planes; and
a controller suitable for determining whether a first read operation for the nonvolatile memory device is a random read operation, and accessing at least one first target plane of the first read operation, according to an access merge process, depending on a determination result,
wherein the controller simultaneously accesses the first target plane and at least one second target plane included in the nonvolatile memory device, according to the access merge process.

2. The memory system according to claim 1,
wherein, according to the access merge process, the controller simultaneously reads data stored in a first target memory unit of the first target plane and data stored in a second target memory unit of the second target plane, and
wherein a position of the second target memory unit is independent of a position of the first target memory unit.

3. The memory system according to claim 1, wherein, according to the access merge process, the controller searches at least one second read operation that is mergeable with the first read operation, among standing-by read operations, and sets, when the second read operation is searched, a target plane of the second read operation as the second target plane.

4. The memory system according to claim 3, wherein the controller determines, when the nonvolatile memory device is able to simultaneously access the first target plane and a target plane of a standing-by read operation, that the standing-by read operation is mergeable with the first read operation.

5. The memory system according to claim 3, wherein the controller keeps the first read operation to stand by, when the second read operation is not searched.

6. The memory system according to claim 3, wherein the controller performs the standing-by read operations based on a standby time of each of the standing-by read operations and a threshold time.

7. The memory system according to claim 1,
wherein the controller simultaneously accesses the first target plane and the second target plane when the first target plane and the second target plane form a simultaneously accessible plane unit, and
wherein the simultaneously accessible plane unit is formed by a predetermined number of planes which are simultaneously accessible by the nonvolatile memory device.

8. The memory system according to claim 7, wherein, when the first target plane and the second target plane do not form the simultaneously accessible plane unit, the controller determines, based on a standby time of the second read operation, whether the second read operation is able to continuously stand by, and simultaneously accesses the first target plane and the second target plane when the second read operation is not able to continuously stand by.

9. The memory system according to claim 8, wherein the controller keeps the first read operation and the second read operation to stand by, when the second read operation is not able to continuously stand by.

10. The memory system according to claim 1, wherein, when the first read operation is a sequential read operation for at least one nonvolatile memory device, the controller groups first target memory units of the first read operation into one or more groups such that target planes configuring each group form the simultaneously accessible plane unit, and processes a group among the groups which does not form the simultaneously accessible plane unit, according to the access merge process.

11. A method for operating a memory system, comprising:
determining whether a first read operation for a nonvolatile memory device is a random read operation; and
accessing at least one first target plane of the first read operation, according to an access merge process, depending on a determination result,
the accessing of the first target plane according to the access merge process comprising:
simultaneously accessing the first target plane and at least one second target plane included in the nonvolatile memory device.

12. The method according to claim 11,
wherein the simultaneously accessing of the first target plane and the second target plane comprises:
simultaneously reading data stored in a first target memory unit of the first target plane and data stored in a second target memory unit of the second target plane, and
wherein a position of the second target memory unit is independent of a position of the first target memory unit.

13. The method according to claim 11, wherein the accessing of the first target plane according to the access merge process comprises:
searching at least one second read operation that is mergeable with the first read operation, among standing-by read operations; and
setting, when the second read operation is searched, a target plane of the second read operation as the second target plane.

14. The method according to claim 13, wherein the searching of the second read operation comprises:
determining, when the nonvolatile memory device is able to simultaneously access the first target plane and a target plane of a standing-by access operation, that the standing-by read operation is mergeable with the first read operation.

15. The method according to claim 13, wherein the accessing of the first target plane according to the access merge process further comprises:
keeping the first read operation to stand by, when the second read operation is not searched.

16. The method according to claim 13, wherein the accessing of the first target plane according to the access merge process further comprises:
performing the standing-by read operations based on a standby time of each of the standing-by read operations and a threshold time.

17. The method according to claim 11,
wherein the accessing of the first target plane according to the access merge process further comprises:
simultaneously accessing the first target plane and the second target plane when the first target plane and the second target plane form a simultaneously accessible plane unit, and
wherein the simultaneously accessible plane unit is formed by a predetermined number of planes which are simultaneously accessible by the nonvolatile memory device.

18. The method according to claim 17, wherein the accessing of the first target plane according to the access merge process further comprises:
to determining, when the first target plane and the second target plane do not form the simultaneously accessible plane unit, based on a standby time of the second read operation, whether the second read operation is able to continuously stand by; and
simultaneously accessing the first target plane and the second target plane when the second read operation is not able to continuously stand by.

19. The method according to claim 18, wherein the accessing of the first target plane according to the access merge process further comprises keeping the first read operation and the second read operation to stand by, when the second read operation is not able to continuously stand by.

20. The method according to claim 11, further comprising:
grouping, when the first read operation is a sequential read operation for at least one nonvolatile memory device, first target memory units of the first read operation into one or more groups such that target planes configuring each group form the simultaneously accessible plane unit; and
processing a group among the groups which does not form the simultaneously accessible plane unit, according to the access merge process.
